(19) United States
(12) Patent Application Publication
(10) Pub. No.: US 2013/0231975 A1
(43) Pub. Date: Sep. 5, 2013

(54) PRODUCT CYCLE ANALYSIS USING SOCIAL MEDIA DATA

(71) Applicants: Elizabeth Ann High, London (GB); Michelle Amanda Evans, Seattle, WA (US); Scott Briggs, Wauconda, IL (US); Russell Taufa, Seattle, WA (US)

(72) Inventors: Elizabeth Ann High, London (GB); Michelle Amanda Evans, Seattle, WA (US); Scott Briggs, Wauconda, IL (US); Russell Taufa, Seattle, WA (US)

(21) Appl. No.: 13/781,672

(22) Filed: Feb. 28, 2013

Related U.S. Application Data
(60) Provisional application No. 61/606,326, filed on Mar. 2, 2012.

(51) Int. Cl. G06Q 30/02; G06Q 50/00

(52) U.S. Cl. CPC G06Q 30/0201; G06Q 50/01
USPC 705/7.29

(57) ABSTRACT

Systems and methods for product cycle analysis using social media data are provided herein. Some exemplary methods may include evaluating social media conversations for an author, executing a semiotic analysis of the social media conversations to categorize the social media conversations, and computing a product commitment score for the author, for social media conversation having been categorize within a product commitment score domain.

### CROSS-REFERENCE TO RELATED APPLICATIONS

This non-provisional patent application claims priority benefit of U.S. Provisional Patent No. 61/606,326, filed on Mar. 2, 2012, titled “PRODUCT CYCLE ANALYSIS USING SOCIAL MEDIA DATA,” which is hereby incorporated by reference herein in its entirety including all references cited therein.

### FIELD OF THE PRESENT TECHNOLOGY

The present technology relates generally to product cycle analysis, and more specifically, but not by way of limitation, the present technology may be utilized to evaluate how well received a product is amongst consumers, predict buying behaviors, and target consumers based upon their position within a product cycle (e.g., learn, try, buy).

### BACKGROUND

Social media communications provide a wealth of information regarding the purchasing behaviors and interests of consumers. While this information is voluminous, it is often difficult to categorize and translate this information into meaningful and actionable information that may be utilized by a company to improve their products, advertising, customer service, and the like.

### SUMMARY OF THE PRESENT TECHNOLOGY

According to some embodiments, the present technology may be directed to a method that comprises: (a) determining, via a social media intelligence system, social media participants in at least one phase of a product cycle for a product; (b) obtaining, via the social media intelligence system, social media data from one or more social media platforms for the participants relative to the product; (c) calculating, via the social media intelligence system, a product commitment score that represents a commitment level of the participants to the product; and (d) providing the product commitment score to an end user client device by the social media intelligence system.

According to some embodiments, the present technology may be directed to a system that comprises: (a) one or more processors; and (b) logic encoded in one or more tangible media for execution by the one or more processors and when executed operable to perform operations comprising: (i) determining, via a social media intelligence system, social media participants in at least one phase of a product cycle for a product; (ii) obtaining, via the social media intelligence system, social media data from one or more social media platforms for the participants relative to the product; (iii) calculating, via the social media intelligence system, a product commitment score that represents a commitment level of the participants to the product; and (iv) providing the product commitment score to an end user client device by the social media intelligence system.

According to some embodiments, the present technology may be directed to a method that comprises: (a) evaluating social media conversations for an author; (b) executing a semiotic analysis of the social media conversations to categorize the social media conversations; and (c) computing a product commitment score for the author, for social media conversation having been categorize within a product commitment score domain.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary product cycle analysis system.

FIG. 2 is a block diagram of an exemplary product cycle application for use in accordance with the present technology.

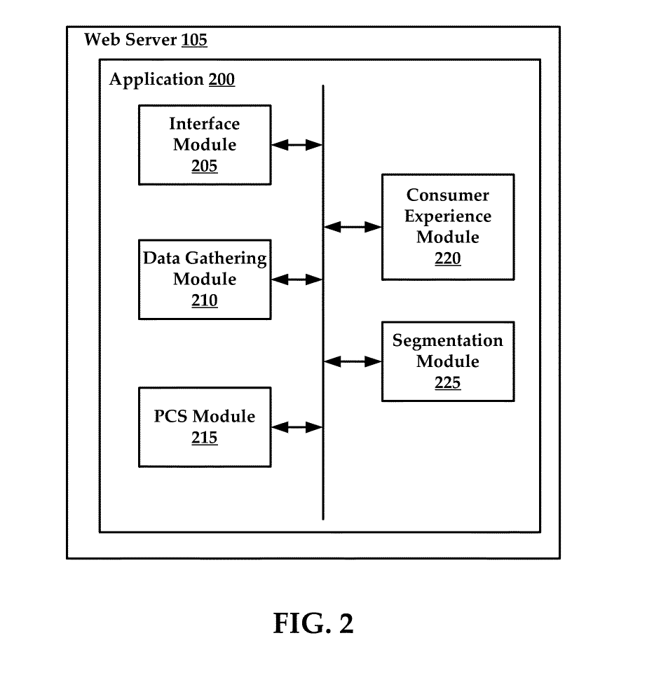

FIG. 3 illustrates various matrices that may be used to semiotically evaluate conversations or other content.

FIG. 4A is a flowchart of an exemplary method for performing product cycle analysis.

FIG. 4B is a flowchart of another exemplary method for performing product cycle analysis.

FIG. 5 is a block diagram of an exemplary computing system for implementing embodiments of the present technology.

### DETAILED DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Generally speaking, the present technology is directed to systems, methods, and media that utilize social media data to evaluate consumer behavior and sentiment for a product, relative to a product cycle. The present technology may calculate various scores that indicate how well received a product is amongst consumers. These scores may also be used to predict buying behaviors and target consumers based upon their position within a product cycle. That is, scores may be calculated that represent consumer experiences across many phases of a product cycle (e.g., development, launch, updating, phase out, and the like).

An exemplary score calculated by the present technology may comprise brand commitment scores that allow marketers to gauge consumer commitment levels relative to products and/or brands.

It will be understood that social media data may include, but is not limited to, social media messages, conversations, posts, feeds, updates, statuses, and so forth. Additionally, consumers may be referred to as authors, as those individuals participating in research, trial, and purchase social media conversations are the intended consumers for a particular product and/or service.

Prior to calculating various scores that indicate how well received a product is amongst consumers, the present technology may evaluate social media conversations from authors and categorize the conversations. In some instances, conversations may be categorized as falling within a product commitment score domain, a brand commitment score domain, and/or a customer relevance score. Generally speaking, conversations may be categorized by evaluating keywords included in the conversations, and more specifically based upon a frequency of keywords. While the following description and examples provided below are directed to analysis of social media conversations, one of ordinary skill in the art will appreciate that the principles described herein may be equally applied to conversations occurring over many other types of digital mediums, such as forums, chat rooms, blogs, websites, comment feeds, and so forth.

According to some embodiments, the various product score domains may be sub-divided into a plurality of action and/or emotion based sub-categories. In some embodiments, each of the product score domains may comprise different weightings for their sub-categories. These weightings may be established by an analysis of empirical data regarding likely consumer behavior and/or consumer sentiments.

In some instances, the present technology may mathematically quantify consumer sentiment relative to a product. Moreover, the consumer sentiment may be extracted from an analysis of content included in social media messages and conversations. Additionally, the portion of the product cycle in which the consumer is currently participating may be determined by an analysis of the words included in their social media data. Therefore, consumer sentiment regarding a product may be determined relative to a time frame associated with at least one phase of a product cycle for the product.

The scores calculated by the present technology may be based upon data included in social media messages of authors (e.g., consumers posting messages on social networks). Thus, social media data obtained from various social media sources may provide valuable and actionable information when transformed by the present technology into various metrics. Each of the metrics/scores/values calculated by the present technology is described in greater detail herein.

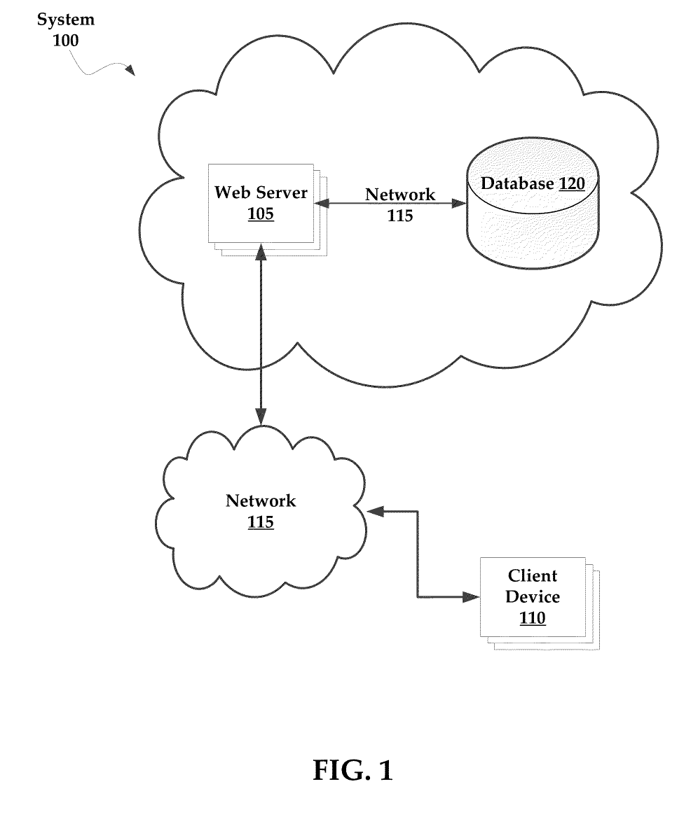

Referring to the collective drawings, the present technology may be implemented to collect and evaluate social media data for product cycle analysis. The present technology may be facilitated by a social media intelligence system 100, hereinafter “system 100” as shown in FIG. 1. The system 100 may be described as generally including a one or more web servers that may communicatively couple with client devices such as end user computing systems. For the purposes of clarity, the system 100 is depicted as showing only one web server 105 and one client device 110 that are communicatively coupled with one another via a network 115. Additionally, social media data gathered from various sources may be stored in database 120, along with various scores, values, and the corresponding data generated by the web server 105, as will be discussed in greater detail below.

It is noteworthy to mention that the network 115 may include any one (or combination) of private or public communications networks such as the Internet. The client device 110 may interact with the web server 105 via a web based interface, or an application resident on the client device 110, as will be discussed in greater detail herein.

According to some embodiments, the system 100 may include a cloud based computing environment that collects, analyzes, and publishes datasets. In general, a cloud-based computing environment is a resource that typically combines the computational power of a large grouping of processors and/or that combines the storage capacity of a large grouping of computer memories or storage devices.

The cloud may be formed, for example, by a network of web servers such as web servers 105 with each web server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

The system 100 may be generally described as a particular purpose computing environment that includes executable instructions that are configured to provide educational and employment based social networks.

In some embodiments, the web server 105 may include executable instructions in the form of a social media intelligence application, hereinafter referred to as “application 200” that collects and evaluates social media data for product cycle analysis. FIG. 18 illustrates and exemplary schematic diagram of the application 200.

The application 200 is shown as generally comprising an interface module 205, a data gathering module 210, a Product Commitment Score (PCS) module 215, a consumer experience module 220, and a segmentation module 225. It is noteworthy that the application 200 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the application 200 may include separately configured web servers.

Generally speaking, the user interface module 205 may generate a plurality of graphical user interfaces that allow end users to interact with the application 200. These graphical user interfaces may allow end users to input information that is utilized by the system 100 to capture and analyze social media data. The information input by end users may include product information for products they desire to evaluate, the product cycle or a portion of the product cycle of interest, the type of consumers or messages they desire to analyze, and so forth.

Initially, the data gathering module 210 may be executed to obtain social media data from one or more social media platforms. End users may establish profiles that define what types of social media data are to be gathered by the data gathering module 210. For example, a software developer may desire to gather social media data regarding consumer sentiment for a particular application.

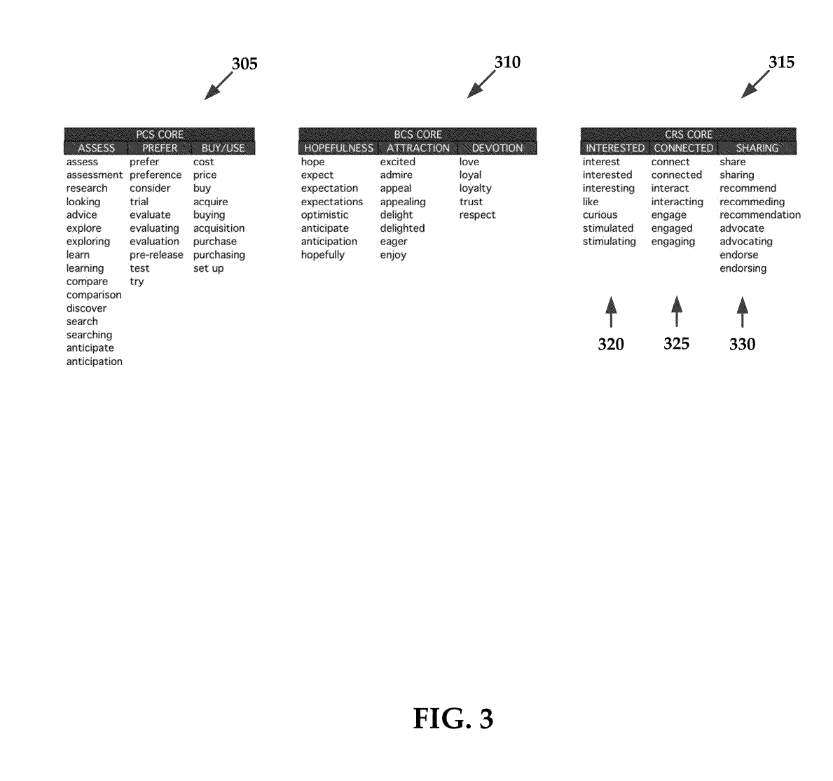

The data gathering module 210 may evaluate social media data for keywords, groups of keywords, or search queries that are utilized to search social media platforms for conversations or messages that include these keywords. FIG. 3 illustrates various matrices that may be used to semiotically evaluate conversations or other content. For example, if a social media conversation has a predominate number of keywords that fall in the customer relevance score (CRS) matrix, the conversation may be categorized as falling within the CRS domain. Thus, a CRS equation may be utilized to calculate a CRS for the social media conversation, as will be discussed in greater detail.

Exemplary PCS core keywords are shown in matrix 305, while exemplary BCS core keywords are included in matrix 310. Exemplary CRS core keywords are included in matrix 315, which includes column 320 of Interested, column 325 of Connected, and column 330 of Sharing. Each of these columns may be associated with a shareability classification in some embodiments. Thus, keywords in a conversation may place the conversation into one or more of these classifications, namely Interested, Connected, and/or Sharing, respectively.

For example, if a conversation included the words sharing and endorsing, which are included in the Sharing column 330, the conversation may be classified within the Sharing classification. The conversation may be placed into more than one classification if the system detects keywords present in the Interested or Connected columns. In some instances, the conversation may be classified by a predominance of classifying words in the conversation. Thus, if the conversation includes a predominate number of Interested keywords, the conversation may be classified as Interested. In some embodiments, these classifications may also be weighted such that the inclusion of a predetermined number of Sharing keywords automatically causes the conversation to be classified with the Sharing classification, regardless of how many other Interested or Connected keywords are present in the conversation.

In accordance with the present disclosure, selection of customer experience data may be influenced by the specific types of behaviors that a merchant is attempting to quantify. In other embodiments, the data gather module 210 may analyze the customer experience data to determine where within the product cycle a consumer currently resides—for example, in the awareness, interest, desire, or action phases. Awareness may be inferred from conversations that discuss any of the three key drivers of the product cycle (e.g., learn, try, buy, and the like). Interest in a product may be a strong indicator that a consumer has gone beyond being simply aware of a product. When consumers expressing a desire to purchase a product it may be inferred to be a strong indicator that consumers are considering a product for purchase. Additionally, when consumers indicate an active intent to purchase a product, it may be inferred that the consumer is strongly progressing along the buying cycle.

In accordance with the present disclosure the selection of social media data may be influenced by the specific types of behaviors that a merchant is attempting to quantify. In other embodiments, the data gather module 210 may analyze the social media data to determine where within the product cycle a consumer currently resides, for example, in the awareness, interest, desire, or action phases. Awareness may be inferred from conversations that discuss any of the three key drivers of the product cycle (e.g., learn, try, buy, and the like). Interest in a product may be a strong indicator that a consumer has gone beyond being simply aware of a product. Consumers expressing a desire to purchase a product may be inferred to be a strong indicator that consumers are considering a product for purchase. Additionally, when consumers indicate an active intent to purchase a product, it may be inferred that the consumer is strongly progressing along the buying cycle.

In some embodiments, the data gathering module 210 may obtain social media data from specific types of consumers, and in additional embodiments, based upon where the consumers are positioned within the product cycle, such as those within the research phase. That is, the social media data for a set of consumers may be monitored because they are actively researching products to purchase.

The data gathering module 210 may utilize a conversation matrix to obtain relevant social media data. The data gathering module 210 may employ the conversation matrix to search and capture relevant social media data from social media platforms. Additional details regarding the establishment of profiles and data gathering, conversation matrices, data analysis, and transmission are provided in Addendum B. The search terms and matrices utilized by the data gathering module 210 may be updated if the data gathering module 210 fails to obtain sufficient data, or if the data that is obtained is inaccurate.

The PCS module 215 may be executed to calculate various types of PCS values that aid merchants in determining the commitment level of consumers to a particular product. Additionally, the PCS value may be utilized as a leading indicator that may be utilized to predict consumer behavior relative to a particular product or service. For example, the PCS value may be used to predict how well a particular product will be received by consumers. Moreover, the PCS value may be used to predict the likelihood that a product will be purchased and if consumers will remain committed to the product throughout the lifecycle of the product. In one non-limiting example, if the product includes software, the product lifecycle may include conception, product launch, and eventual upgrade of the software by consumers.

The PCS value may represent the difference between the number of positive research, trial, and purchase messages and the number of negative research, trial and purchase messages. Again, these messages include social media messages may be obtained by the data gathering module 205 from evaluating one or more social media platforms.

It is noteworthy to mention that the PCS module 215 may calculate individual PCS values at a specific consumer (e.g., author) level. Adjustments and weighting of consumer level PCS values may also be performed by the PCS module 215.

For example, each consumer may contribute to the overall PCS value to the degree of their relative authority. That is, the PCS module 215 may account for a consumer's influence relative to the total influence of all consumers having at least one research, trial or purchase conversation relative to a particular product.

The PCS module 215 may also adjust consumer level PCS values to account for each consumer's influence relative to the influence of all consumers having at least one research, trial or purchase message. That is, the more influential a consumer is, the more weight is attributed to the consumer's conversations. Influence may be inferred because the consumer has a large social network or because the consumer is an expert in the product field.

The overall PCS value may generally comprise a summation consumer level PCS values. In additional embodiments the overall PCS value (and consumer level PCS values) may comprise a summation of three different component values such as a research value, a trial value, and a purchase value, where each of these values may be calculated separately. These three values represent the phases of the product cycle. An exemplary algorithm for calculating an overall PCS value is shown on page three of Addendum C. Addendum C is attached hereto and is hereby incorporated by reference herein in its entirety including all references cited therein.

In general, each of the three component values may each include a summation of seven different sentiment values. Conceptually, the seven sentiment values exist on a continuum where the first sentiment value indicates a very negative sentiment, and the seventh sentiment value indicates a very positive sentiment. The second through sixth sentiments fall somewhere in between. The distributions of messages/conversations along the spectrum of sentiment values may indicate the success of the product at the different phases of the product cycle. The spectrum/continuum of sentiment values is illustrated on page three of Addendum B.

In some embodiments, messages that are most positive (sentiment score of seven) may receive the most points, whereas the least positive (sentiment score of five) may receive the least amount of positive points. The most negative conversations (sentiment score of one) may receive the greatest number of negative points. Conversations being the least negative (sentiment score of four) may receive the fewest negative points.

As mentioned briefly above, consumer level PCS scores may also be weighted. For example, a consumer having 100% most positive conversations in the research, trial and purchase categories should get the maximum score of 100. As such, the weight for sentiment seven=100/3=+33.33.

Likewise, a consumer having 100% most negative conversation in the research, trial and purchase categories should get the minimum score=−100. As such, the weight for sentiment 1=−100/3=−33.33.

Consumers that have less negative conversations than sentiment one, a decrease in penalization points of −33.33 may be seen, respecting the original weighting. As consumers have less positive conversations their reward points may be reduced to respect the original weighting.

In sum, the PCS module 215 may consider not only the aggregate number of conversations in each phase of the product cycle, but the sentiment level associated with each conversation. Additionally, the sentiment for each conversation may be weighted based upon consumer characteristics (e.g., mood, influence, etc.). Moreover, the conversations may further be weighted by the authority level of the consumers associated with the conversations. The final PCS score (either overall or consumer level) may then be index from zero to 100, where 100 indicates that the product scores perfectly through the product cycle or at least one phase of the product cycle.

The present technology may be adapted to adjust the consumer level and overall PCS values based upon various factors. For example, a value calculated for the sentiment of a message may be adjusted for the consumer's general mood, such as when it is known that the consumer is always positive or almost always skeptical and/or negative. In other instances the PCS values may be adjusted based upon the importance of a particular message to the sale of a product or service.

While many methods for calculating and weighting PCS scores have been disclosed one or ordinary skill in the art will appreciate that other algorithms and weighting methodologies that may be utilized to quantify and predict consumer sentiment and buying behaviors for product cycles are likewise contemplated for use in accordance with the present technology. An exemplary algorithm is described in greater detail below.

PCS values may also be utilized to benchmark a particular product against a competing product. For example, a PCS value for a navigation software application for a first merchant may be compared against a PCS value for similar navigation software from a competing merchant. The PCS value may provide actionable information that allows the first merchant to modify their marketing, consumer service, and/or product features to increase their PCS value. It is noteworthy to mention that PCS values may be generated for merchants at specific intervals, such as daily, weekly, monthly, or quarterly.

According to some embodiments, the consumer experience module 220 may be executed to evaluate portions of the consumer journey (e.g. product cycle) relative to a product. Generally speaking, consumer experience values may comprise mathematical representations of social media data at specific point in time (or a specific time period) along the product cycle. In some instances, the consumer experience scores may include the three PCS component values (e.g., research value, trial value, and purchase value) described above, but analyzed relative to a particular time frame. Therefore, the consumer experience values may be described as more granular and temporally focused portion of the PCS score (either intermediate or overall).

Consumers may be previously identified by the data gathering module 210, for example, by identifying consumers in certain types of survey data. Various scores may be generated by the consumer experience module 220 that represent different consumer experiences. These scores/values may be utilized by merchants to improve their products and/or marketing campaigns.

Using the consumer experiences scores, a merchant may explore more detailed metrics regarding the touchpoints surrounding a product. In some instances, the consumer experience scores may be generated by conducting a more detailed evaluation of consumer's social media data relative to the calculation of a PCS score. Therefore, the conversation matrices employed by the data gathering module 210 may be modified (e.g., may include greater detail) to capture more specific portions of social media conversations/messages across each phase of the product cycle.

The consumer experience module 220 may also generate optimal consumer journey models that enable merchants to plan effective product development and marketing strategies, while also allowing for course correction when products or marketing fail to produce acceptable consumer experiences.

According to some embodiments, the segmentation module 225 may be executed to determine and develop actionable priorities tailored to specific consumer types. The segmentation module 225 may cluster consumers based on a variety of factors using a segmentation model that considers product cycle components and likelihood of purchasing a product. The segmentation module 225 may utilize the social data gathered by the data gathering module 210. Additionally, the segmentation module 225 may generate feedback for consumer segments in near real-time, specifically for consumers that are the most (and alternatively the least) likely to purchase a particular product.

In some embodiments, the data gathering module 210, consumer social media data may be obtained from groups of consumers engaged in traditional marketing or consumer research activities. Consumers may be queried for a social networking identifier (e.g., handle, profile, username, etc.) such that the data gathering module 210 may collect social media data for that consumer. When social media data is obtained, the segmentation module 225 may link or correlate the social media data with primary research data, such as data obtained from traditional marketing or consumer research activities. The segmentation module 225 may evaluate social media data of the consumer to determine if the consumer is acting in correspondence with the research data gathered about the consumer. Moreover, the segmentation module 225 may also determine if the consumer is influencing other consumers with their social media conversations.

The segmentation module 225 may also used the combined data sets to generate models that allow the segmentation module 225 to predict which social media conversations that should be tracked to glean the most accurate and relevant information about the consumer.

In other embodiments, the segmentation module 225 may utilize the correlated group consumers into categories based upon various factors. For example, very influential consumers who focus on superior customer service may be clustered into a consumer segment.

The segmentation module 225 may segment or cluster the social media data based upon the content of the social media conversations. For example, the segmentation module 225 may evaluate a group of social media messages and determine that two thirds of the consumers desire superior consumer service, whereas only five percent desire an aesthetically pleasing website. Again, the clustering, as with sentiment analysis, may be conducted based upon keywords included in the social data. As with PCS values and consumer experience values, the segmentation module 225 may determine the segmentation of social media data based upon certain algorithms, mathematical, and/or statistical methodologies. According to some embodiments, the segmentation module 225 may employ statistical methodologies such as clustering ensembles. The clustering of consumers allows the merchant to direct more resources to consumer service efforts and away from website development. As consumer sentiments change, so may the segmentation, and thus the priorities of the merchant.

Addendum D illustrates problems and solutions that embodiments of application 200 may address and implement, respectively. Addendum D is attached hereto and is hereby incorporated by reference herein in its entirety including all references therein.

Based upon the categorization of the social media conversation, the BCS module 230 may be executed to calculate a BCS score for a social media conversation. According to some embodiments, the BCS score that quantifies brand affinity for a consumer. The BCS score may also quantify the consumer's emotions regarding the brand and provides a metric, which allows merchants to build relationships between customers and brands.

The BCS score is a composite calculation that encompasses the understand, explore, and commit segments of the product cycle. The BCS score relates to the product cycle inasmuch as the understand segment of the product cycle is associated with hopefulness, the explore segment of the product cycle is associated with attraction, and the commit segment of the product cycle is associated with devotion. Keywords conveying these emotions may be used to categorize a social media conversation as falling within the brand commitment domain.

In greater detail, the hopefulness emotion attempts to quantify what is important to a customer. Using this metric, merchants may be able to align expectations of their consumers with their brand. Merchants may tailor their branding and/or marketing to set a level of expectation regarding their products. The tailoring of branding may be utilized to adjust erroneous customer expectations or alternatively increase undesirably low customer expectations.

The attraction emotion attempts to quantify if the brand properly reflects who their customers are. Using this metric, merchants may be able to identify reconciliation when needed. Merchants may tailor their branding and/or marketing to ensure that their products are being advertised and/or branded in accordance with the needs of their customers. These needs may comprise reputation, quality, popularity, and so forth.

The devotion emotion attempts to quantify how deeply the consumer is committed to the brand. Using this metric, merchants may be able to identify a relationship status between a brand and a consumer. The more devoted the customer is to the brand, the more committed the customer will be to purchasing the product associated with the brand. Merchants may wish to tailor their branding or marketing to drive up customer devotion and identify consumers with lagging commitment.

Because these metrics and resultant BCS scores may be tracked over time and per author, the merchant may determine how changes in marketing and/or branding strategies affect these different consumer emotions. BCS scores may be calculated for groups or consumer segments such as demographic, psychographic, or other common consumer segmentations that would be known to one of ordinary skill in the art with the present disclosure before them.

An exemplary algorithm (Equation A) for calculating a PCS for a social media conversation is provided below:

Σ(Ar/ΣAr)*Cw*Sa (Equation A)

where an author rank score Ar is first calculated for each of a group of authors. The group of authors may include the known customers or alternatively, a subgroup of customers. An author rank may be calculated by determining an influence for an author. The influence of an author may be determined, for example, by a number of connections for the author (e.g., followers, contacts, etc.). The social status of an author may also be considered. For example, an influential celebrity may have their conversations ranked more highly than an average consumer in some embodiments.

Once an author rank score has been calculated for each author in the group of authors, the author rank score for the author of the comment may be divided by a sum of the author rank scores for each author in the author group to generate an adjusted author rank score. The author rank scores and/or adjusted author rank score may be calculated over a given period of time, relative to a particular product. Thus, PCS may be calculated over time to provide merchants with indices or metrics that quantify how well their branding efforts are being received by consumers.

Next, a component weight Cw for the conversation may be multiplied with the adjusted author rank score. The component weight may comprise previously established scaling factors for each stage of the product cycle. For example, the understand/hopefulness scaling factor may be approximately 0.15, whereas the explore/attraction scaling factor may be approximately 0.25. Additionally, the commit/devotion scaling factor may be approximately 0.6. Thus, in some embodiments, the most important scaling factor for component weight relative to the PCS is the assess/prefer/buy(use) scaling factor. Advantageously, the assess/prefer/buy(use) scaling factor may be attributed more weight because the PCS attempts to determine a product commitment level for consumers. Therefore, buy(use) conversations may be strongly correlated to product commitment, whereas prefer and/or assess are less likely to be indicative of product commitment, although they may be contributory to some degree.

As mentioned previously, the component weighting for each of these three scaling factors may be determined based upon empirical evidence, such as the evaluation of social media conversations of trustworthy authors. For example, a plurality of conversations gathered from various trustworthy consumers may be utilized as the basis for setting the weight of individual scaling factors.

While the above-described example illustrates the calculation of a PCS score for determining product commitment levels, the same equation may be utilized to calculate BCS and/or CRS scores that quantify customer brand commitment, and customer relevance, respectively.

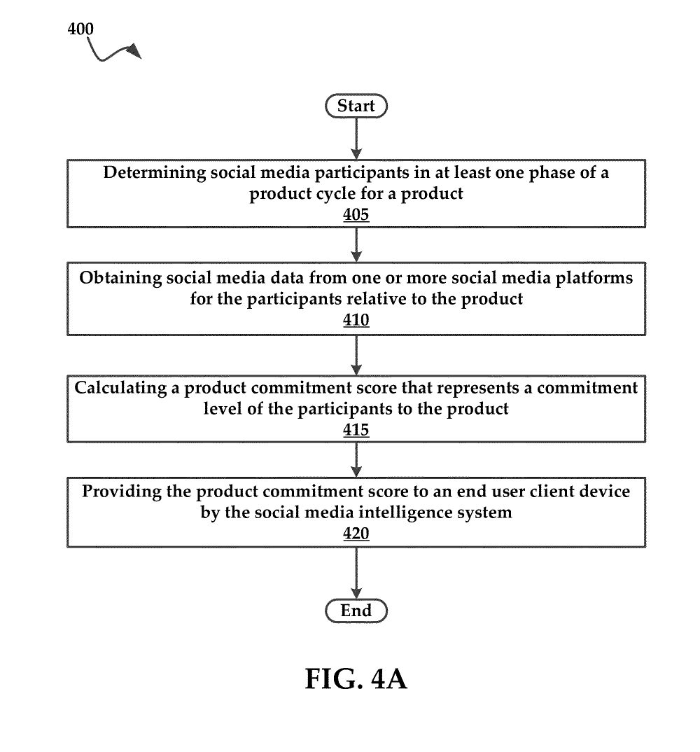

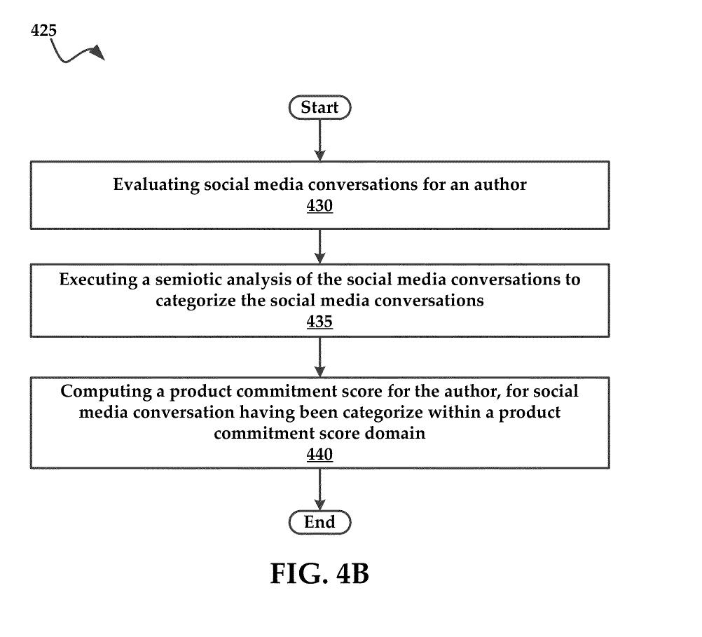

FIG. 4A is a flowchart of an exemplary method 400 for executing a product cycle analysis of social media data. The method may comprise a step 405 of determining social media participants in at least one phase of a product cycle for a product. These participants may also be referred to as an “author.” The method 400 may also comprise a step 410 of obtaining social media data from one or more social media platforms for the participants relative to the product. For example, the method may include obtaining social media conversations for one or more authors.

Next, the method may comprise a step 415 of calculating a product commitment score that represents a commitment level of the participants to the product. Additionally, the method may include a step 420 of providing the product commitment score to an end user client device by the social media intelligence system.

FIG. 4B is a flowchart of another exemplary method 425 for executing a product cycle analysis of social media data. The method may comprise a step 430 of evaluating social media conversations for an author. Additionally, the method may comprise a step 435 of executing a semiotic analysis of the social media conversations to categorize the social media conversations, as well as a step 440 of computing a product commitment score for the author, for social media conversation having been categorize within a product commitment score domain.

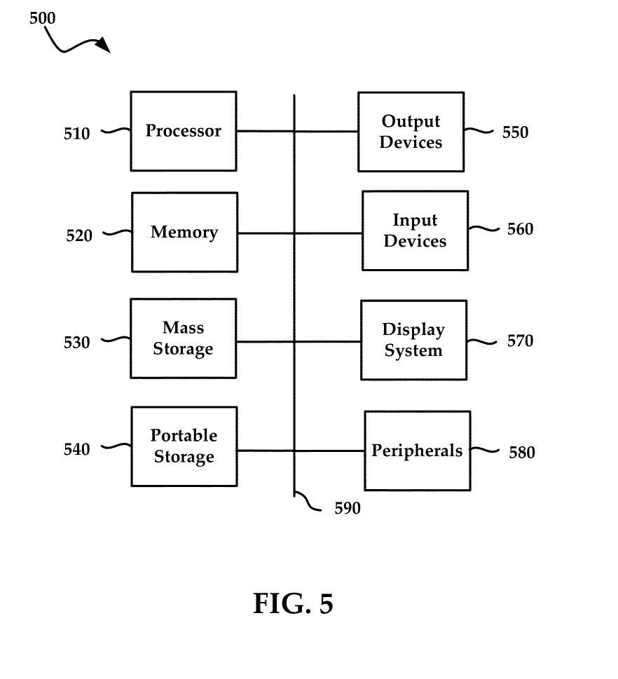

FIG. 5 illustrates an exemplary computing system 500 that may be used to implement an embodiment of the present technology. The system 500 of FIG. 5 may be implemented in the contexts of the likes of computing systems, networks, servers, or combinations thereof disclosed herein. The computing system 500 of FIG. 5 includes one or more processors 510 and main memory 520. Main memory 520 stores, in part, instructions and data for execution by processor 510. Main memory 520 may store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. The components may be connected through one or more data transport means. Processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 may store the system software for implementing embodiments of the present technology for purposes of loading that software into main memory 520.

Portable storage device 540 operates in conjunction with a portable non-volatile storage medium, such as a floppy disk, compact disk, digital video disc, or USB storage device, to input and output data and code to and from the computer system 500 of FIG. 5. The system software for implementing embodiments of the present technology may be stored on such a portable medium and input to the computer system 500 via the portable storage device 540.

Input devices 560 provide a portion of a user interface. Input devices 560 may include an alphanumeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. Peripheral device(s) 580 may include a modem or a router.

The components provided in the computer system 500 of FIG. 5 are those typically found in computer systems that may be suitable for use with embodiments of the present technology and are intended to represent a broad category of such computer components that are well known in the art. Thus, the computer system 500 of FIG. 5 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Macintosh OS, Palm OS, Android, iPhone OS and other suitable operating systems.

It is noteworthy that any hardware platform suitable for performing the processing described herein is suitable for use with the technology. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method, comprising:
determining, via a social media intelligence system, social media participants in at least one phase of a product cycle for a product;
obtaining, via the social media intelligence system, social media data from one or more social media platforms for the participants relative to the product;
calculating, via the social media intelligence system, a product commitment score that represents a commitment level of the participants to the product; and
providing the product commitment score to an end user client device by the social media intelligence system.

2. The method according to claim 1, wherein calculating comprises evaluating the social media data by determining keywords included in the social media data that reflect product commitment, the social media data being determined from social media conversations of an author.

3. The method according to claim 2, wherein determining keywords comprises comparing keywords in the social media data to a matrix of words that reflect any of assess, prefer, and buy behaviors of the author.

4. The method according to claim 2, wherein calculating comprises computing an author rank for the author, the author rank comprising an analysis of any of social media connections, social status, and combinations thereof, wherein the author rank is associated with an influence for the author.

5. The method according to claim 4, further comprising computing an adjusted author rank score by dividing the author rank by a sum of author ranks for a plurality of authors, the author rank being one of the plurality of author ranks.

6. The method according to claim 5, further comprising calculating a component weight for a conversation of the author.

7. The method according to claim 6, further comprising:
determining a product commitment score scaling factor, based upon an analysis of keywords included in the social media conversations;
adjusting the scaling factor, such that:
the scaling factor for keywords associated with buy behaviors is highest;
the scaling factor for keywords associated with prefer behaviors is lower than the scaling factor for keywords associated with buy behaviors; and
and the scaling factor for keywords associated with assess behaviors is lower than the scaling factor for keywords associated with prefer behaviors.

8. The method according to claim 7, further comprising multiplying the adjusted author rank with the component weight and the scaling factor to generate the product commitment score.

9. The method according to claim 2, wherein the author includes a trusted author.

10. A system, comprising:
one or more processors; and
logic encoded in one or more tangible media for execution by the one or more processors and when executed operable to perform operations comprising:
determining, via a data gathering module, social media participants in at least one phase of a product cycle for a product;
obtaining, via the data gathering module, social media data from one or more social media platforms for the participants relative to the product;
calculating, via a product commitment score module, a product commitment score that represents a commitment level of the participants to the product; and
providing the product commitment score to an end user client device by the social media intelligence system.

11. The system according to claim 10, wherein the product commitment score module is configured to evaluate the social media data by determining keywords included in the social media data that reflect product commitment, the social media data being determined from social media conversations of an author.

12. The system according to claim 11, wherein the product commitment score module is configured to determine keywords by comparing keywords in the social media data to a matrix of words that reflect any of assess, prefer, and buy behaviors of the author.

13. The system according to claim 12, wherein the product commitment score module is configured to calculate an author rank for the author, the author rank comprising an analysis of any of social media connections, social status, and combinations thereof, wherein the author rank is associated with an influence for the author.

14. The system according to claim 13, wherein the product commitment score module is configured to compute an adjusted author rank score by dividing the author rank by a sum of author ranks for a plurality of authors, the author rank being one of the plurality of author ranks.

15. The system according to claim 5, wherein the product commitment score module is configured to a component weight for a conversation of the author.

16. The system according to claim 16, wherein the product commitment score module is configured to:
determine a product commitment score scaling factor, based upon an analysis of keywords included in the social media conversations;
adjust the scaling factor, such that:
the scaling factor for keywords associated with buy behaviors is highest;
the scaling factor for keywords associated with prefer behaviors is lower than the scaling factor for keywords associated with buy behaviors; and
and the scaling factor for keywords associated with assess behaviors is lower than the scaling factor for keywords associated with prefer behaviors.

17. The system according to claim 16, wherein the product commitment score module is configured to multiply the adjusted author rank with the component weight and the scaling factor to generate the product commitment score.

18. The method according to claim 11, wherein the author includes a trusted author.

19. A method, comprising:
evaluating social media conversations for an author;
executing a semiotic analysis of the social media conversations to categorize the social media conversations; and
computing a product commitment score for the author, for social media conversation having been categorize within a product commitment score domain.

20. The method according to claim 19, wherein executing a semiotic analysis further comprises:
establishing a plurality of domain matrices including a product commitment score domain, a brand commitment score domain, and a consumer relevance score domain, each of the plurality of domain matrices comprising keywords used to categorize a social media conversation;
comparing keywords in the social media conversations to the plurality of matrices of domain matrices; and
associating each of the social media conversations with at least one of the plurality of domain matrices, based upon the comparison.
